(19) United States
(12) Patent Application Publication
(10) Pub. No.: US 2024/0097465 A1
(43) Pub. Date: Mar. 21, 2024

(54) PORTABLE ENERGY STATION, STACKED ARRANGEMENT AND METHOD FOR PRODUCING A PORTABLE ENERGY STATION

(71) Applicant: FESTOOL GMBH, Wendlingen (DE)

(72) Inventors: Bernd OBERMEIER, Herrenberg (DE); Marco Christoph BROSCH, Wolfschlugen (DE); Volker KAUPP, Tübingen (DE); Patrick SCHÖN, Schwäbisch Gmünd (DE)

(21) Appl. No.: 18/255,294

(22) PCT Filed: Nov. 25, 2021
(86) PCT No.: PCT/EP2021/082905

§ 371 Date: May 31, 2023

(30) Foreign Application Priority Data
Dec. 4, 2020 (DE) 10 2020 215 390.6

(51) Int. Cl. H02J 7/00; H02M 1/10

(52) U.S. Cl. CPC H02J 7/0063; H02J 7/0029; H02J 7/0042; H02J 7/0048; H02M 1/10

(57) ABSTRACT

A portable power station that includes a box-shaped housing, an energy storage device which is arranged in the housing and is configured to provide an AC voltage, an AC voltage port arrangement at which the AC voltage for an external consumer, in particular a power tool and/or a vacuum cleaner, can be tapped, and a coupling interface for coupling the portable power station to at least one coupling object designed as a system box or vacuum cleaner, in order to form a vertically tension-proof stack together with the at least one coupling object.

The invention relates to a portable power station, comprising a box-shaped housing, an energy storage device arranged in the housing, which energy storage device is configured to provide an AC voltage, and an AC voltage port arrangement, at which the AC voltage for an external consumer, in particular a power tool and/or a vacuum cleaner, can be tapped.

It is an object of the invention to provide an power station that is easy to handle.

The object is solved by a portable power station according to claim 1. The portable power station comprises a coupling interface for coupling the portable power station to at least one coupling object configured as a system box or vacuum cleaner to form a vertically tension-proof stack together with the at least one coupling object.

The portable power station can thus be stored and/or transported in a vertically tension-proof stack and is consequently easy to handle.

Advantageous further developments are defined in the dependent claims.

The invention further relates to a stack arrangement according to claim 18 and a method of manufacturing a portable power station according to claim 20.

Exemplary embodiments are explained below with reference to the drawing. Thereby shows

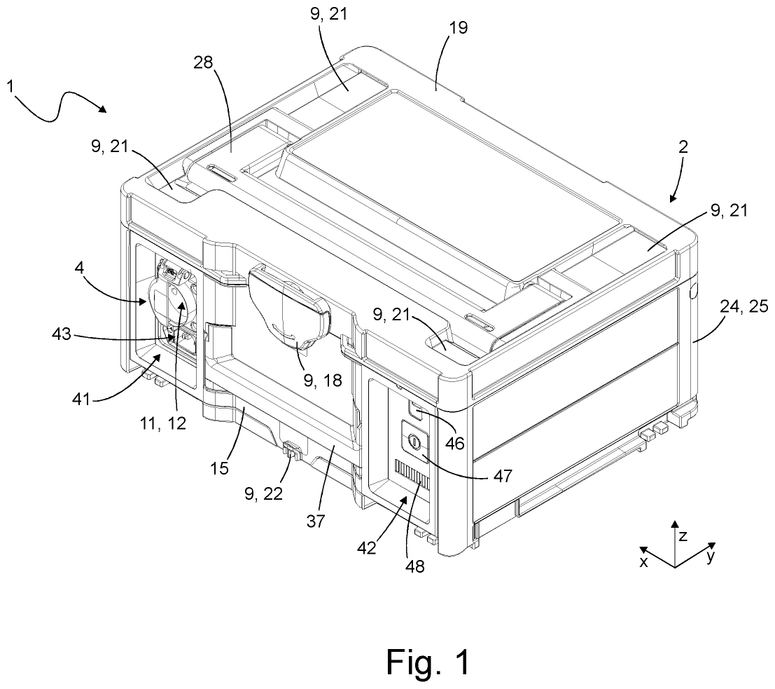

FIG. 1 a perspective view from above of a transportable power station,

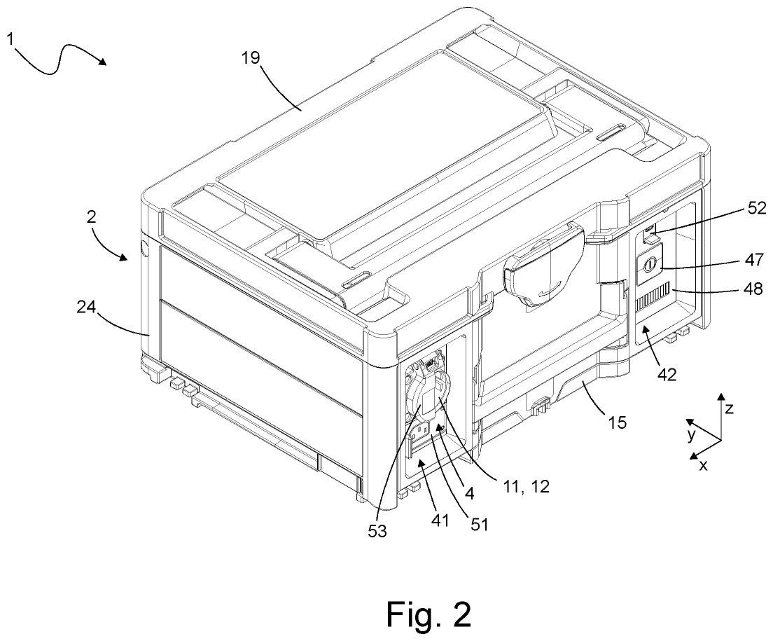

FIG. 2 another perspective view from above of the transportable power station with port covers,

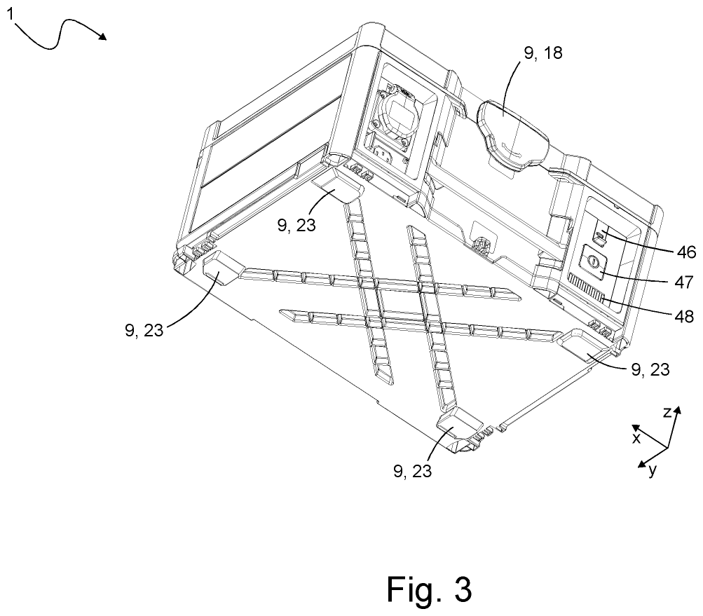

FIG. 3 a perspective view of the transportable power station from below,

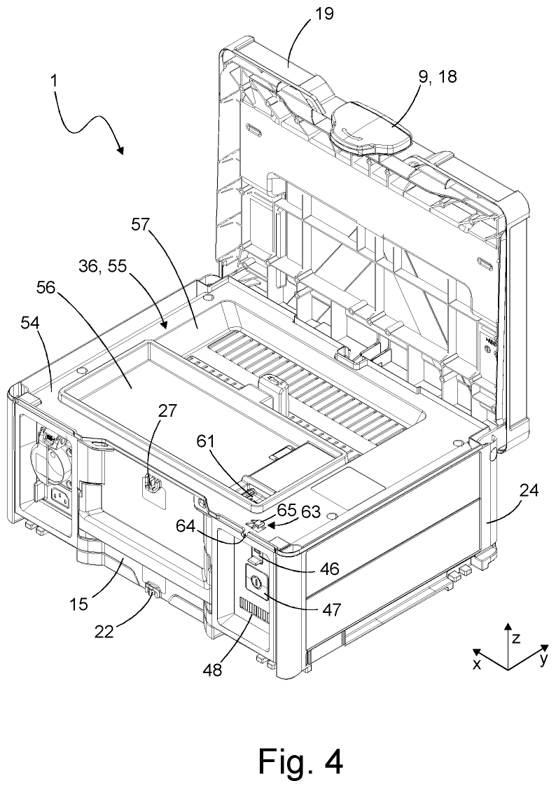

FIG. 4 a perspective view from above of the transportable power station with the cover open,

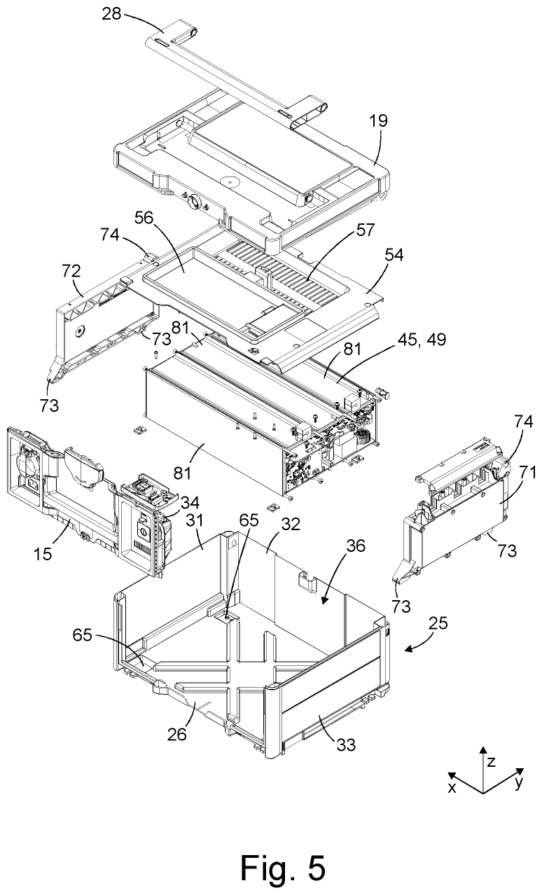

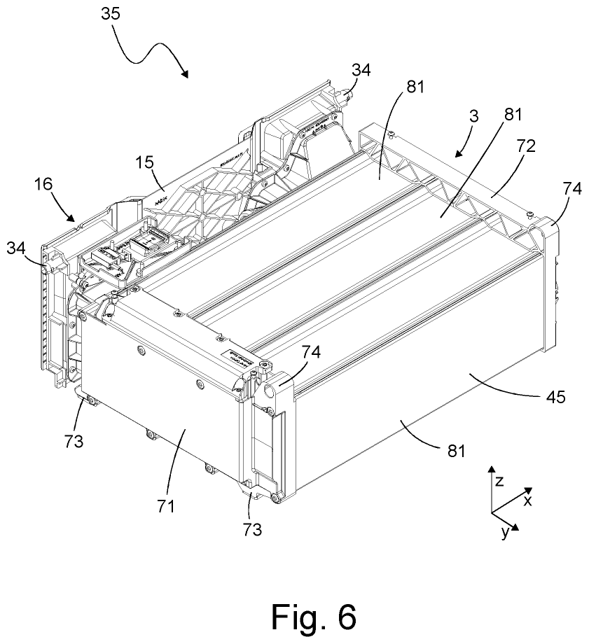

FIG. 5 an exploded view of the transportable power station FIG. 6 an energy storage assembly of the transportable power station,

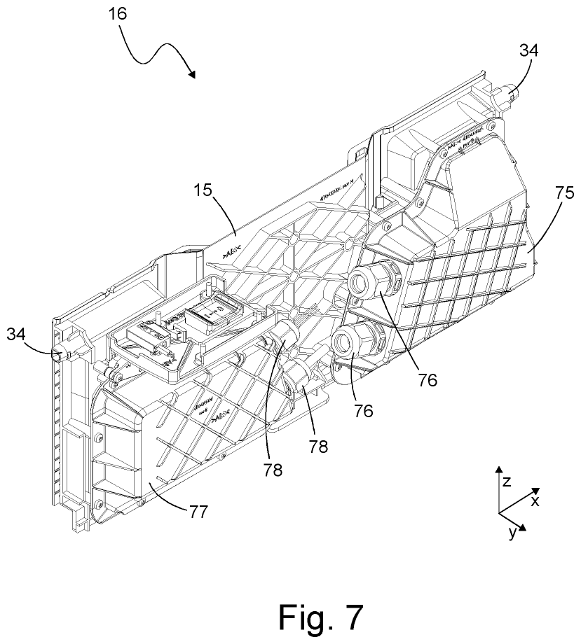

FIG. 7 a port wall assembly of the transportable power station,

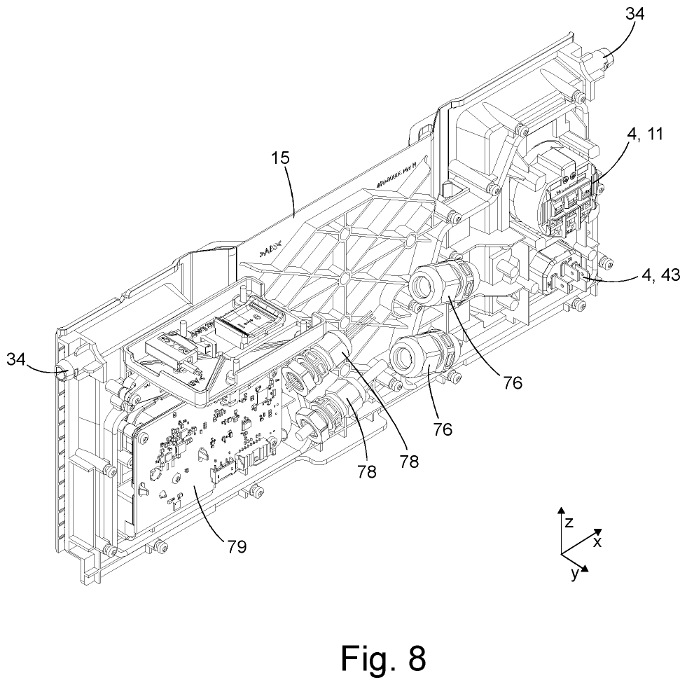

FIG. 8 the port wall assembly, wherein the sealing covers are not shown,

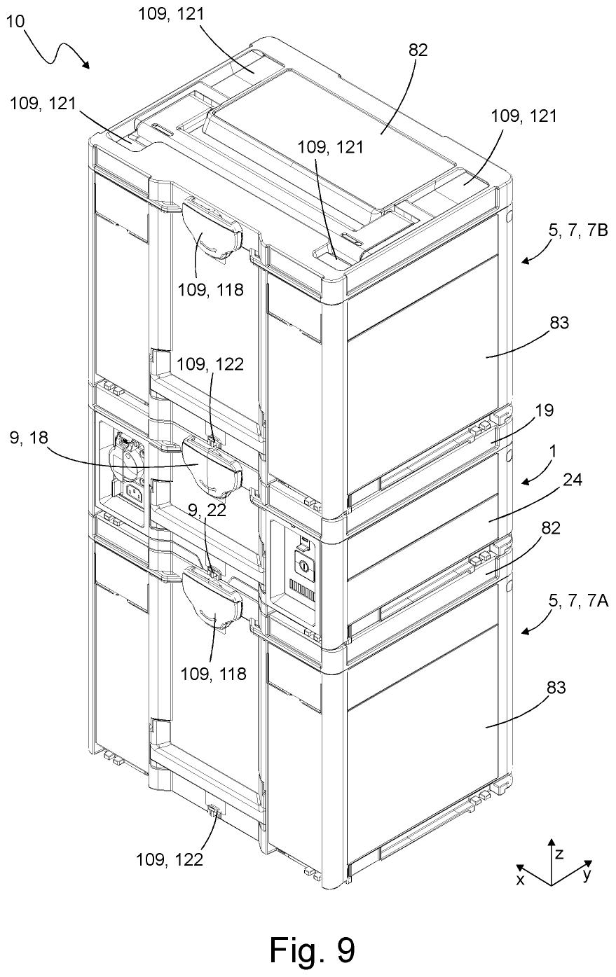

FIG. 9 a first stack arrangement comprising a lower system box, the transportable power station and an upper system box,

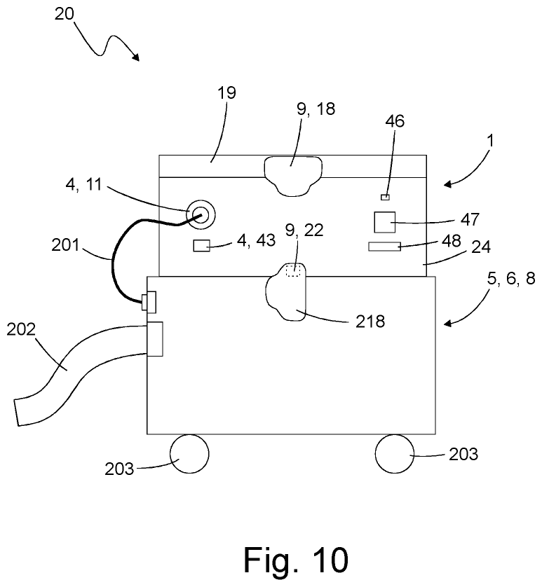

FIG. 10 a second stack arrangement of a vacuum cleaner and the transportable power station,

In the following explanations, reference is made to the x-direction, y-direction and z-direction shown in the figures, which are aligned orthogonally to one another. The x-direction can also be referred to as the longitudinal direction, the y-direction as the transverse direction, and the z-direction as the height direction. The x-direction and y-direction are horizontal directions, while the z-direction is a vertical direction.

FIG. 1 shows an exemplary embodiment of a portable power station 1. The portable power station 1 may also be referred to as a portable energy storage. By the term “portable” it is meant that the power station 1 can be carried by a person. Thus, the weight and dimensions of the power station 1 are such that it can be carried by a person. For example, the power station 1 weighs less than 25 kg, less than 20 kg, or less than 18 kg. Furthermore, the power station 1 is preferably less than 450 mm long (in the x-direction) and/or less than 350 mm wide (in the y-direction) and/or (with the upper carrying handle 28 folded in) less than 500 mm high (in the z-direction).

The portable power station 1 has a box-shaped housing 2. The box-shaped housing 2 is the outer housing of the power station 1. By the term “box-shaped” is meant in particular the shape of a cuboid.

The portable power station 1 has an energy storage device 3 arranged in the housing 2 (see e.g. FIG. 6), which is configured to provide an AC voltage. The AC voltage has in particular a sinusoidal shape. In particular, the AC voltage corresponds to the mains voltage. Preferably, the AC voltage has an effective value of 220 V to 240 V and/or a frequency of 50 Hz or 60 Hz. Further, the AC voltage may have an effective value of 120 V and/or a frequency of 60 Hz. Further, the AC voltage may have a different effective value and/or frequency. When providing the AC voltage, the energy storage device 3 preferably provides a power, in particular a continuous power, of at least 2 kW or at least 3 kW, preferably of 3.68 kW. Preferably, when providing the AC voltage, the energy storage device 3 provides a peak power of 11 kW and/or 7.2 kW. The energy output by the energy storage device 3 when providing the AC voltage is stored in the energy storage device 3. For example, the energy storage device 3 has a storage capacity of at least 1 kW or at least 1.5 kW and/or less than 2 kW. The power station 1 is configured to provide the AC voltage and, in particular, one or more of the aforementioned power outputs in a state in which the power station 1 is not connected to a power supply.

The portable power station 1 further comprises an AC voltage port arrangement 4. The AC voltage for an external consumer 6 (see e.g. FIG. 10), in particular a power tool and/or a vacuum cleaner 8, can be tapped at the AC voltage port arrangement 4. Exemplarily, the AC voltage port arrangement 4 comprises an AC voltage port 11, in particular a socket, at which the AC voltage can be tapped. The AC voltage port 11 is preferably designed as a SchuKo port 12 (SchuKo=protective contact). The AC voltage port arrangement 4, in particular the AC voltage port 11, is arranged on the outside on a port wall 15 of the housing 2, and is expediently accessible from the outside, in particular without having to open the cover 19 explained below.

By the term “outside”, in particular with respect to the housing 2 or a wall of the housing 2, for example of the peripheral walls 31, 32, 33, the bottom wall 26 or the port wall 15, shall be meant in particular the wall side facing outwards to the environment of the power station 1. By the term “inside” or “inside”, in particular with respect to the housing 2 or a wall of the housing 2, for example of the peripheral walls 31, 32, 33, the bottom wall 26 or the port wall 15, shall be meant in particular the wall side facing inwards towards the housing interior 36.

The portable power station 1 further comprises a coupling interface 9. The coupling interface 9 serves for coupling the portable power station 1 to at least one coupling object 5 designed as a system box 7 (see e.g. FIG. 9) or vacuum cleaner 8 (see e.g. FIG. 10), in order to form a vertically tension-proof stack together with the at least one coupling object 5. Exemplarily, the coupling interface 9 comprises an upper coupling device and/or a lower coupling device. The upper coupling device serves for coupling the portable power station 1 to an upper coupling object 5 placed on the power station 1, in particular an upper system box 7B (see e.g. FIG. 9). The lower coupling device is used to couple the portable power station 1 to a lower coupling object 5, in particular a lower system box 7A (see e.g. FIG. 9) or a vacuum cleaner 8 (see e.g. FIG. 10), on which the portable power station 1 is placed.

The upper coupling device exemplarily comprises an upper coupling element 18, which is designed in particular as a movable coupling element, expediently as a rotary latch, in particular as a T-shaped rotary latch. Exemplarily, the upper coupling element 18 is arranged at a front side of the housing 2. The front side is the side on which the port wall is located. Expediently, the upper coupling element 18 is arranged on the cover 19 of the housing 2, in particular pivotably mounted on the cover 19.

Exemplarily, the upper coupling device further comprises an upper coupling structure 21 having, in particular, a plurality of coupling recesses exemplarily arranged on the upper side of the housing 2, in particular of the cover 19, exemplarily in the four corner regions of the upper side.

The lower coupling device comprises, by way of example, a lower coupling element 22, which is designed in particular as a non-movable coupling element, expediently as a coupling projection. The lower coupling element 22 is arranged on the front side, in particular on the port wall 15, in particular in the lower region.

Exemplarily, the lower coupling device further comprises a lower coupling structure (see, e.g., FIG. 3) having, in particular, a plurality of stand feet 23 arranged on the bottom side of the housing 2, exemplarily in the four corner regions of the bottom side.

The upper coupling device of the power station 1 is couplable to a lower coupling device of the coupling object 5 having an identical coupling interface (to the coupling interface 9). Furthermore, the lower coupling device of the power station 1 is couplable to an upper coupling device of the coupling object 5 having an identical coupling interface (to the coupling interface 9).

By means of the coupling interface 9, a vertically tension-proof coupling between the power station 1 and the coupling object 5 can be established. The term “vertically tension-proof”refers to a fastening that remains effective when subjected to a tensile load in the vertical direction. A coupling object 5 coupled to (in particular under) the power station 1 in a vertically tension-proof manner remains coupled to the power station 1 even when the power station 1 is lifted vertically and is consequently lifted along with it. Preferably, by means of the coupling interface 9, a fixed coupling, in particular fastening, of the power station 1 to the coupling object 5 can be established in all directions. The coupling provided by means of the coupling interface 9 can be established without tools and/or can be released without tools, in particular by performing a manual actuation of the upper coupling element 18 (and/or an upper coupling element of the coupling object 5).

Exemplarily, the box-shaped housing 2 has a lower part 24 and the cover 19 disposed on the lower part 24. In particular, the cover 19 has a rectangular horizontal outer contour and covers the entire upper surface of the lower part 24. The cover 19 is pivotally attached to the rear wall of the lower part 24 and can be selectively moved to an open or a closed position by pivoting. The cover 19 represents the upper side of the housing 2, in particular of the power station 1. The upper carrying handle 28 is arranged on the upper side of the cover 19, which upper carrying handle 28 is designed in particular to be bow-shaped and/or to fold out upwards.

Inside the housing 2 is a housing interior 36, which is bounded in particular by the lower part 24 and the cover 19. The cover 19 closes the housing interior 36.

Exemplarily, a front carrying handle 37 is arranged on the front side, in particular the port wall 15, of the lower part 24, which handle is designed in particular to be bow-shaped and/or to fold out towards the front.

The front of the housing 2, in particular the port wall 15, has three front areas arranged next to each other in the x-direction on the outside. A first front area is arranged centrally in the x-direction. A second front area is located (in x-direction) on a first side (e.g. left) of the first front area and a third front area is located on a second side (e.g. right) (in x-direction) of the first front area. The first front region is set back from the second and third front regions in the y-direction, thus forming an indentation. In the first front area, the upper coupling element 18, the lower coupling element 22 and/or the front carrying handle 37 are arranged in an exemplary manner.

The second front region has a first front recess 41 in the y-direction, which has in particular a rectangular cross-section, in particular a rectangular x-z cross-section, and preferably extends over at least 75% of the vertical extent of the port wall 15. The third front region of the front side of the housing 2 has a second recess 42 in the y-direction, which in particular has a rectangular cross-section, in particular a rectangular x-z cross-section, and preferably extends over at least 75% of the vertical extent of the port wall 15. The first front recess 41 is preferably shaped identically to the second front recess 42—thus, in particular, has the same dimensions.

In the second front area, in particular the first front recess 41, the AC voltage port arrangement 4, in particular the AC voltage port 11, is arranged by way of example. Preferably, the AC voltage port arrangement 4 is located completely within the first front recess 41—i.e., in particular, it does not protrude outside of the first front recess 41.

Expediently, the power station 1, in particular the AC voltage port arrangement 4, comprises a charging port 43, via which an energy storage unit 45 (see e.g. FIG. 5) can be electrically charged. The charging port 43 is exemplarily designed as a cold appliance port. Preferably, the charging port 43 is arranged in the vertical direction below the AC voltage port 11. Expediently, the charging port 43 is arranged in the first front recess 41.

Preferably, the power station 1 further comprises a DC voltage port 46, in particular a USB port, at which a DC voltage can be tapped. The energy for providing the DC voltage originates from the energy storage unit 45. Exemplarily, the DC voltage port 46 is arranged on the outside of the port wall 15, in particular in the second front recess 42. The DC voltage port 46 can optionally be designed for charging a power tool battery. According to an embodiment not shown, the power station comprises a battery interface into which a power tool battery can be inserted and which has a DC voltage port for charging the power tool battery.

Preferably, the power station 1 further comprises an external power switch 47 arranged externally on the box-shaped housing 2 for switching on and/or switching off the AC voltage (provided at the AC voltage port 11). In particular, the external power switch 47 is arranged in the second recess 42, exemplarily in vertical direction below the DC voltage port 46.

Preferably, the power station 1 comprises a state-of-charge indicator 48 having a plurality of lighting sections which are arranged next to one another, in particular in the x-direction. The power station 1, in particular a state-of-charge indicator control unit of the power station 1, is preferably designed to light up the lighting sections in accordance with a state of charge of the energy storage device 3, in particular of the energy storage unit 45, expediently in such a way that the number of lighting sections lighting up is proportional to the current state of charge.

The state-of-charge indicator 48 is expediently arranged on the outside of the housing 2, in particular on the outside of the port wall 15. Preferably, the state-of-charge indicator 48 is arranged in the second front recess 42. In particular, the state-of-charge indicator 48 is arranged in a vertical direction below the external power switch 47.

Preferably, the state-of-charge indicator 48 is not a graphical display. For example, the state-of-charge indicator 48 is a simple LED arrangement.

Preferably, the power station 1 is configured to further indicate, via the lighting sections of the state-of-charge indicator 48, a fault condition. Preferably, the power station 1 is configured to detect the fault condition. The fault condition is, for example, a temperature that is too high, a current that is too high, and/or a defect in an electronic component. Preferably, the power station 1 is configured to display a flashing pattern with the lighting sections of the state-of-charge indicator 48 to indicate the fault state and/or to display a different color than to indicate the state-of-charge.

Expediently, the DC voltage port 46, the external power switch 47, and/or the state-of-charge indicator 48 are located entirely within the second front recess 42—in particular, do not protrude outside of the second front recess 42.

FIG. 2 shows the power station 1 with port covers 51, 52, 53. Exemplarily, the power station 1 has a first port cover 51, which covers the charging port 43 in particular in a sealing manner. The first port cover 51 is made of a flexible material, for example rubber, and is exemplarily attached to the outside of the housing 2, in particular the port wall 15. The first port cover 51 is manually removable from the charging port 43 to expose the charging port 43. The first port cover 51 has, for example, a tab by which the first port cover 51 can be gripped and pulled off the charging port 43.

Preferably, the power station 1 further comprises a second port cover 52, which covers the DC voltage port 46 in particular in a sealing manner. The second port cover 52 is made of a flexible material, for example rubber, and is exemplarily attached to the outside of the housing 2, in particular the port wall 15. The second port cover 52 is manually removable from the DC voltage port 46 to expose the DC voltage port 46. For example, the second port cover 52 has a tab by which the second port cover 52 can be gripped and pulled away from the DC voltage port 46.

Exemplarily, the power station 1 comprises a third port cover 53 which covers the AC voltage port 11, in particular in a sealing manner. The third port cover 53 is shown in half-section in FIGS. 1, 2, 4, 5 and 9. The third port cover 53 is attached to the outside of the housing 2, in particular the port wall 15. Exemplarily, the third port cover 53 has a cover section, in particular a circular one, which is pivotably mounted on the housing 2.

In FIG. 4, the power station 1 is shown in a state in which the cover 19 is in the open position so that the housing interior 36 is accessible from the outside. Preferably, the power station 1 has an energy storage cover 54, which is designed in particular as a horizontally oriented cover plate. The energy storage cover 54 occupies the entire x-y extension of the housing interior 36. For example, the energy storage cover 54 is tray-shaped. The energy storage cover 54 divides the housing interior 36 into an energy storage space (located below the energy storage cover 54) in which the energy storage device 3 is arranged, and a storage space 55 (located above the energy storage cover 54) which is accessible from the outside when the cover 19 is open. The storage space 55 is a flat space into which, by way of example, no tools fit. The energy storage cover 54, which is the bottom of the storage space 55, is arranged in particular on the upper side of the lower part 24.

The energy storage device 3, in particular the energy storage space, preferably occupies at least 80% of the height of the lower part 24. The energy storage cover 54 is arranged on the energy storage device 3. The energy storage cover 54 has a storage recess 56 for small parts and/or a cell phone. The storage recess 56 is accessible via the cover 19—that is, when the cover 19 is open. When the cover 19 is closed, the housing interior 36, in particular the storage space 55 and/or the storage recess 56, is not accessible from the outside.

In an exemplary embodiment, the storage recess 56 is elongated and oriented with its longitudinal axis parallel to the x-direction. In an exemplary embodiment, the storage recess 56 is arranged in a front region of the energy storage cover 54.

The energy storage cover 54 expediently further comprises a charging cable receptacle 57 for receiving an energy storage charging cable for charging the power station 1. According to an embodiment not shown, the energy storage charging cable is located in the charging cable receptacle 57. In an exemplary embodiment, the charging cable receptacle 57 is configured as a recess separate from the storage recess 56. The charging cable receptacle 57 is elongated and oriented with its longitudinal axis parallel to the x-direction. In an exemplary embodiment, the charging cable receptacle 57 is disposed in a rear region of the energy storage cover 54. In particular, the storage recess 56 and the charging cable receptacle 57 are arranged next to each other in the y-direction.

Preferably, the power station 1 comprises a main power switch 61 arranged in the housing interior 36, in particular in the storage space 55, for switching on and/or switching off the AC voltage (provided at the AC voltage port 11). Exemplarily, the main power switch 61 is arranged on the energy storage cover 54, particularly in a corner portion of the storage recess 56. The main power switch 61 is expediently accessible from the outside only when the cover 19 is open, and is not accessible from the outside when the cover 19 is closed. The cover 19 can be locked in the closed position, in particular by engaging the upper coupling element 18 with a locking projection 27 arranged on the port wall 15.

As mentioned above, the power station 1 further comprises the external power switch 47, arranged externally on the box-shaped housing 2, for switching on and/or switching off the AC voltage. According to a preferred embodiment, the AC voltage (provided at the AC voltage port 11) cannot be switched on via the external power switch 47 when the AC voltage is switched off by means of the main power switch 61. In particular, the power station 1 provides the AC voltage at the AC voltage port 11 only when both the main power switch 61 and the external power switch 47 are switched on. Preferably, the main power switch 61 and/or the external power switch 47 is communicatively connected to AC voltage control electronics of the energy storage device 3. The AC voltage control electronics are configured to assume a sleep state, in particular a deep-sleep state, in response to the switched-off state of the main power switch 61 and to provide no AC voltage at the AC voltage port 11 in this sleep state, even if the external power switch 47 is in the switched-on state.

Preferably, the power station 1 comprises a cable guide arrangement 63 for guiding a charging cable from the DC voltage port 46 (in particular arranged on the outside of the housing 2) to the storage recess 56 (in particular arranged in the housing interior 36, preferably the storage space 55). According to an embodiment not shown, a cell phone is arranged in the storage recess 56 and the charging cable runs from the DC voltage port 46 via the cable guide arrangement 63 to the cell phone. In an exemplary embodiment, the cable guide arrangement 63 comprises a cable guide recess 64 arranged in a vertical direction above the DC voltage port 46 and provided in an upper edge of the port wall 15, through which the charging cable can be guided. Exemplarily, the cable guide arrangement 63 further comprises a cable guide clip 66, in particular a hook-shaped cable guide clip 66, under which the charging cable can be clamped and which is arranged in particular in the storage space 55.

FIG. 5 shows an exploded view of the power station 1. Exemplarily, the lower part 24 comprises a lower part main section 25, in particular in one piece, for example manufactured as an injection molded part, which has a bottom wall 26 and three peripheral walls 31, 32, 33 extending upwardly from the bottom wall. The bottom wall 26 is the bottom wall of the lower part 24 and the peripheral walls 31, 32, 33 are peripheral walls of the lower part 24. The peripheral walls 31, 32, 33 include a first peripheral wall 31 which is a first side wall (oriented perpendicular to the x-direction), a second peripheral wall 32 which is a rear wall (oriented perpendicular to the y-direction), and a third peripheral wall 33 which is a second side wall (oriented perpendicular to the x-direction). In particular, the lower part main section 25 has the shape of a (in particular cuboidal) box with an open front and an open top.

Preferably, the lower part 24 further has the port wall 15 inserted into the lower part main section 25. The port wall preferably has a rectangular shape. The port wall 15 forms a fourth peripheral wall—in particular the front wall (aligned perpendicular to the y-direction)—of the lower part 24. The AC voltage port arrangement 4 is arranged on the port wall 15. The port wall 15 laterally has, in particular bolt-shaped, port wall latching projections 34 which are latched into latching openings arranged on the lower part main section 25, in particular on the inside of the first peripheral wall 31 and third peripheral wall 33. The port wall 15 expediently extends over at least 80% of the x-extension of the power station 1 and/or over at least 70% of the z-extension of the power station 1.

FIG. 6 shows an energy storage assembly 35 formed by the port wall 15, in particular a port wall assembly 16, and the energy storage device 3.

The energy storage device 3 has a cuboid energy storage unit 45 and two end caps 71, 72, which are placed on the energy storage unit 45 on two opposite sides, in particular end faces, of the energy storage unit 45 and support the energy storage unit 45 with respect to the bottom wall 26 of the housing 2. The end caps 71, 72 are each flat, in particular plate-shaped, and are expediently respectively oriented with their largest side in terms of area perpendicular to the x-direction. The end caps 71, 72 are placed on the sides of the energy storage unit 45 oriented perpendicular to the x-direction and expediently cover these sides completely. Exemplarily, the end caps 71, 72 are screwed to the energy storage unit 45.

The energy storage assembly 35 is inserted into the lower part main section 25 and, in particular, is attached thereto without screws.

As mentioned above, the coupling interface 9 has stand feet 23 arranged at the bottom of the housing 2. Inside the housing 2—i.e. in the housing interior 36—at those points where the stand feet 23 are present on the outside, insertion recesses 65 are present, into which fastening projections 73 of the end caps 71, 72 are inserted. The fastening projections 73 of the end caps 71, 72 project downwards in particular and can also be referred to as fastening feet. The insertion recesses 65 are arranged on the upper side of the bottom wall 26 at those x-y regions which are occupied on the lower side of the bottom wall 26 by the stand feet 23.

The end caps 71, 72 have end cap fastening openings 74, which in particular form the (in the z-direction) upper, (in the y-direction) rear corner regions of the end caps 71, 72. Fastening bolts made in particular of plastic are inserted into these end cap fastening openings 74, which are guided in particular from the outside through the housing 2, in particular the first and third peripheral walls 31, 33, and fasten the end caps 71, 72 to the housing 2.

The end cap 71 shall also be referred to as the first end cap 71 and the end cap 72 shall be referred to as the second end cap 72. Exemplarily, the first end cap 71 comprises the AC voltage control electronics for providing the AC voltage to the AC voltage port 11.

The energy storage unit 45 has an energy storage outer housing 49, which is preferably made of aluminum. The energy storage unit 45 expediently occupies at least 70% of the x-extension of the housing interior 36 and/or at least 70% of the y-extension of the housing interior 36.

In an exemplary embodiment, the energy storage unit 45 comprises a plurality of, in particular three, elongated module arrangements 81, each of which may also be referred to as a “grid”. The module arrangements 81 each have a plurality of, for example six, energy storage modules. Each energy storage module has a plurality of battery cells. The energy storage unit 45 as a whole may also be referred to as a battery. The electrical energy output to the AC voltage port 11 originates from the battery cells of the energy storage unit 45. The energy storage unit 45 expediently occupies at least 50%, at least 60%, or at least 70% of the total volume of the housing interior 36.

Preferably, the energy storage device 3 has a plurality of energy storage subunits, each of which provides a partial DC voltage, and the energy storage device 3, in particular the AC voltage control electronics, is configured to provide the basic form of the AC voltage (provided at the AC voltage port 11) by time-varyingly interconnecting the partial DC voltages and thus without using an inverter. The energy storage subunits are, for example, the energy storage modules.

According to an alternative embodiment, the energy storage device 3 may comprise an inverter, in particular a conventional inverter, to generate the AC voltage (provided at the AC voltage port 11) based on a total DC voltage provided by the energy storage unit 45.

FIGS. 7 and 8 show the port wall assembly 16 comprising the port wall 15. The port wall assembly 16 comprises the AC voltage port arrangement 4, which is accessible from the outside and is arranged on the port wall 15, in particular is inserted into the port wall 15. The port wall assembly 16 further comprises a first sealing cover 75 attached to the inside of the port wall 15, which covers and seals the AC voltage port arrangement 4 with respect to the housing interior 36. The first sealing cover 75 is designed in particular in the shape of a trough and is fastened, in particular screwed tight, with its open, in particular concave, side to the inside of the port wall 15. Cable glands 76 are provided on the outside of the first sealing cover 75, through which power cables are routed from the energy storage device 3 to the AC voltage port arrangement 4.

Preferably, the port wall assembly 16 further comprises a second sealing cover 77 attached to the inside of the port wall 15, which covers and seals the DC voltage port 46 with respect to the housing interior 36. The second sealing cover 77 is designed in particular in the form of a trough and is fastened, in particular screwed, with its open, in particular concave, side to the inside of the port wall 15. Cable glands 78 are provided on the outside of the second sealing cover 77, through which at least one cable is guided from the energy storage device 3 to the DC voltage port 46. Exemplarily, the second sealing cover 77 further seals the external power switch 47 and/or the state-of-charge indicator 48 and/or the state of charge control unit from the housing interior 36. Exemplarily, the port wall assembly 16 includes a port wall circuit board 79 attached to the inner side of the port wall 15 and sealed from the housing interior 36 by the second sealing cover 77. The port wall circuit board 79 includes control electronics assigned to and/or associated with the DC power port 46, the external power switch 47, and/or the state-of-charge indicator 48.

FIG. 9 shows a stack arrangement 10, which shall also be referred to as the first stack arrangement 10. The stack arrangement 10 is cuboid-shaped. Preferably, the stack arrangement 10 has a constant horizontal outer contour over its entire vertical extent. The stack arrangement 10 comprises the portable power station 1 and a lower coupling object 5 designed as a system box 7A, on which the portable power station 1 is placed. Preferably, the portable power station 1 is coupled to the lower system box 7A via the coupling interface 9 so that the portable power station 1 together with the lower system box 7A forms a vertically tension-proof stack.

Exemplarily, the stack arrangement 10 further comprises an upper coupling object 5 configured as a system box 7B, which is placed on the portable power station 1. Preferably, the portable power station 1 is coupled to the upper system box 7B via the coupling interface 9 so that the portable power station 1 together with the lower system box 7A and the upper system box 7B form a vertically tension-proof stack.

The system boxes 7A, 7B are in particular modular tool boxes. Preferably, the system boxes 7A, 7B have a respective system box lower part 83 on which a respective system box cover 82 is placed, which is in particular identical to the cover 19. The system boxes 7A, 7B are each cuboid-shaped.

The system boxes 7A, 7B each have a system box coupling interface 109 that is identical in design to the coupling interface 9. In particular, the system box coupling interface 109 comprises an upper coupling element 108 configured identically to the upper coupling element 18 of the coupling interface 9, a lower coupling element 122 configured identically to the lower coupling element 22 of the coupling interface 9, an upper coupling structure 121 configured identically to the upper coupling structure 21 of the coupling interface 9, and a lower coupling structure configured identically to the lower coupling structure of the coupling interface 9.

Thus, the lower system box 7A has an upper coupling device that provides a vertically tension-proof coupling to the lower coupling device of the power station 1. Preferably, an upper coupling element 118 of the lower system box 7A is in engagement with the lower coupling element 22 of the power station 1. In FIG. 9, an exemplary position of the upper coupling element 118 is shown in which this engagement is not provided. Furthermore, the lower coupling structure, in particular the stand feet 23, of the power station 1 is in engagement with the upper coupling structure 121 of the lower system box 7A. The engagement of the lower coupling structure with the upper coupling structure 121 results in particular in a horizontal overlap of the lower coupling structure with the upper coupling structure 121, so that a form closure effective in the height direction is achieved, which contributes to the vertically tension-proof coupling.

The upper system box 7B has a lower coupling element that provides a vertically tension-proof coupling to the upper coupling element of the power station 1. Preferably, the upper coupling element 18 of the power station 1 is engaged with the lower coupling element 122 of the upper system box 7B. In FIG. 9, an exemplary position of the upper coupling element 18 is shown in which this engagement is not present. Furthermore, a lower coupling structure, in particular stand feet, of the upper system box 7B is in engagement with the upper coupling structure 21 of the power station 1.

The power station 1 and the system boxes 7A, 7B have the same horizontal outer contour. Due to the vertically tension-proof coupling between the power station 1 and the system boxes 7A, 7B, when the upper system box 7B is lifted vertically, the power station 1 and the lower system box 7A are also lifted by the vertical lifting.

FIG. 10 shows a stack arrangement 20, which shall also be referred to as a second stack arrangement 20. The second stack arrangement 20 comprises the portable power station 1 and a lower coupling object 5 designed as a vacuum cleaner 8, on which the portable power station 1 is placed, wherein the portable power station 1 is coupled to the vacuum cleaner 8 via the coupling interface 9, so that the portable power station 1 together with the vacuum cleaner 8 forms a vertically tension-proof stack.

The vacuum cleaner 8 represents an external consumer 6 that is supplied with electrical energy by the power station 1 via the AC voltage port 11. Exemplarily, the vacuum cleaner 8 is connected to the AC voltage port 11 via a vacuum cleaner power cable 201.

The vacuum cleaner 8 has a suction hose 202 for sucking up dust and/or rollers 203 by means of which the vacuum cleaner 8 is supported relative to the floor and can be moved.

The vacuum cleaner 8 has an upper coupling device, which is in particular identical to the upper coupling device of the power station 1. The upper coupling device of the vacuum cleaner 8 is coupled to the lower coupling device of the power station 1 to provide a vertically tension-proof coupling between the power station 1 and the vacuum cleaner 8. In particular, the vacuum cleaner 8 has an upper coupling element 218 that engages with the lower coupling element 22. Further, the vacuum cleaner 8 has an upper coupling structure that engages with the lower coupling structure, in particular the stand feet 23. In particular, the upper coupling element 218 is configured identically to the upper coupling element 18. In particular, the upper coupling structure is designed identically to the upper coupling structure 21.

Preferably, there is further provided an arrangement (not shown in the figures) comprising the power station 1 and a power tool, in particular a semi-stationary machine, the power tool being electrically connected to and electrically powered from the AC voltage port 11, in particular from the energy storage unit 45.

In the following, a method for manufacturing the portable power station 1 will be explained. According to the method, the lower part main section 25 is provided. Further, the energy storage assembly 35 is provided. For example, the end caps 71, 72 are screwed to the energy storage assembly 35, and the port wall assembly 16 is attached to the resulting energy storage assembly 3, in particular, to a side of the energy storage assembly 35 oriented perpendicular to the y-direction. The energy storage assembly 35 is then inserted into the lower part part main section 25. In this process, the fastening projections 73 are inserted into the insertion recesses 65. Further, the port wall latching projections 34 are latched into the latching openings. Expediently, further, the fastening bolts are inserted into the end cap fastening openings 74. Consequently, the energy storage assembly 35 is fastened to the lower part main section 25, in particular without screws. Preferably, further, the energy storage cover 54 is placed on the energy storage device 3 and fixed in particular with screws. Expediently, the cover 19 is further fixed to the lower part main section 25.

According to a possible method of using the power station 1, the first stack arrangement 10 is formed with the power station 1 and, before and/or after that, the second stack arrangement 20 is formed with the power station 1.

1. A portable power station, comprising:
a box-shaped housing,
an energy storage device arranged in the housing and configured to provide an AC voltage,
an AC voltage port arrangement at which the AC voltage for an external consumer is tappable, and
a coupling interface for coupling the portable power station to at least one coupling object designed as a system box or vacuum cleaner in order to form a vertically tension-proof stack together with the at least one coupling object.

2. The portable power station according to claim 1, wherein the box-shaped housing has a lower part comprising a lower part main section having a bottom wall and three peripheral walls extending upwardly from the bottom wall, the lower part further having a port wall which is inserted into the lower part main section and forms a fourth peripheral wall of the lower part and on which the AC voltage port arrangement is arranged.

3. The portable power station according to claim 2, wherein the energy storage device together with the port wall forms an energy storage assembly which is inserted into the lower part main section and is fastened thereto.

4. The portable power station according to claim 1, wherein the box-shaped housing has a lower part-PO and a cover disposed on the lower part and closing a housing interior.

5. The portable power station according to claim 4, further comprising a main power switch arranged in the housing interior for switching on and/or switching off the AC voltage.

6. The portable power station according to claim 5, further comprising an external power switch arranged on the outside of the box-shaped housing for switching on and/or switching off the AC voltage.

7. The portable power station according to claim 6, wherein the AC voltage cannot be switched on via the external power switch when the AC voltage is switched off by means of the main power switch.

8. The portable power station according to claim 4, wherein the energy storage device occupies at least 80% of the height of the lower part and an energy storage cover with a storage recess for small parts and/or a cell phone is arranged on the energy storage device, which storage recess is accessible when the cover is open.

9. The portable power station according to claim 1, wherein the AC voltage port arrangement comprises a port having a protective contact and/or a cold appliance port.

10. The portable power station according to claim 1, further comprising a DC voltage port, at which a DC voltage can be tapped.

11. The portable power station according to claim 4, wherein the energy storage device occupies at least 80% of the height of the lower part and an energy storage cover with a storage recess for small parts and/or a cell phone is arranged on the energy storage device, which storage recess is accessible when the cover is open, wherein the portable power station further comprises a DC voltage port, at which a DC voltage can be tapped, wherein the DC voltage port is arranged externally on the housing, and the portable power station further comprises a cable guide arrangement for guiding a charging cable from the DC voltage port to the storage recess.

12. The portable power station according to claim 1, further comprising a state-of-charge indicator having a plurality of lighting sections that light up according to a state-of-charge of the energy storage device, wherein the state-of-charge indicator is adapted to further indicate, via the lighting sections, a fault condition.

13. The portable power station according to claim 1, wherein the energy storage device has a cuboidal energy storage unit and two end caps which are placed on the energy storage unit at two opposite sides of the energy storage unit and support the energy storage unit against a bottom wall of the housing.

14. The portable power station according to claim 13, wherein one of the end caps comprises AC voltage control electronics for providing the AC voltage.

15. The portable power station according to claim 13, wherein the coupling interface has stand feet arranged at the bottom of the housing and insertion recesses are provided inside the housing at those places where the feet are provided on the outside, in which insertion recesses fastening projections of the end caps are inserted.

16. The portable power station according to claim 1, wherein the housing comprises a port wall on which the AC voltage port arrangement, which is accessible from the outside, is arranged, and a first sealing cover attached to the inside of the port wall, which first sealing cover seals the AC voltage port arrangement with respect to the housing interior.

17. The portable power station according to claim 1, wherein the housing comprises a port wall, on which a DC voltage port, which is accessible from the outside, is arranged, and a second sealing cover attached to the inside of the port wall, which second sealing cover seals the DC voltage port with respect to the housing interior.

18. A stack arrangement comprising a portable power station according to claim 1 and a lower coupling object designed as a system box or as a vacuum cleaner, on which the portable power station is placed, wherein the portable power station is coupled to the lower coupling object via the coupling interface, so that the portable power station together with the lower coupling object forms a vertically tension-proof stack.

19. The stack arrangement according to claim 18, further comprising an upper system box placed on the portable power station, wherein the portable power station is further coupled to the upper system box via the coupling interface such that the portable power station together with the lower coupling object and the upper system box forms a vertically tension-proof stack.

20. A method of manufacturing a portable power station according to claim 3, comprising the steps:
providing the lower part main section,
providing the energy storage assembly, and
inserting the energy storage assembly into the lower part main section.
